(19) United States
(12) Patent Application Publication
(10) Pub. No.: US 2026/0359607 A1
(43) Pub. Date: Nov. 12, 2026

(54) METHOD FOR INTEGRATING TRAINED TRANSFORMER INTO OTHER NEURAL NETWORKS, AND APPARATUS THEREFOR

(71) Applicants: Won-Gi PAENG, Seoul (KR); Daesuk KWON, Seoul (KR); HYNTEL INC., Seoul (KR)

(72) Inventors: Won-Gi PAENG, Seoul (KR); Daesuk KWON, Seoul (KR)

(21) Appl. No.: 19/515,435

(22) PCT Filed: Aug. 29, 2024
(86) PCT No.: PCT/KR2024/012926

§ 371 Date: Feb. 27, 2026

(30) Foreign Application Priority Data
Aug. 30, 2023 (KR) 10-2023-0114083
Aug. 28, 2024 (KR) 10-2024-0116084

(51) Int. Cl. G06N 3/0455; G06N 3/084

(52) U.S. Cl. CPC G06N 3/0455; G06N 3/084

(57) ABSTRACT

The present invention proposes a method for integrating a trained transformer model into other neural networks and operating same without an error, so as to enable harmonious operation with other neural networks by inheriting and expanding training that was already performed without having to retrain a transformer model from the beginning for processing an unknown token that has not been learned.

### TECHNICAL FIELD

The present disclosure relates to a neural network architecture and, more specifically, to a transformer which is an attention-based sequence-transforming neural network model.

### BACKGROUND ART

A transformer, which is an attention-based sequence-transforming neural network model, proposed by Google in 2017 in a paper titled “Attention Is All You Need,” has significantly improved upon the limitations of conventional recurrent neural network (RNN) models, and since then, the neural network technology using the attention mechanism has been widely used in various applications such as translation, text generation, chatbots, image generation, and composition.

Recently, various language models have been announced, such as OpenAI's ChatGPT, Google's Bard, Meta's LLaMA, Stanford University's Alpaca, and LMSYS.org's Vicuna, and they show potential as artificial general intelligence that may be utilized in various fields as well as text generation.

FIG. 1 is an example of a transformer neural network model in the conventional art. The transformer model has a variety of types, such as a model having both an encoder and a decoder as presented in a 2017 paper by Google, a model having only an encoder such as BERT, and a model having only a decoder such as GPT or LLaMA, and FIG. 1 illustrates a structure having only an encoder or a decoder.

The transformer model 100 illustrated in FIG. 1 may include various layers such as an input transducer 105, n stacked decoder (or encoder) blocks 110, 155, and 160, a transposed embedding 165, and a softmax 170.

Each of the decoder/encoder blocks 110, 155, and 160 may include a first layer norm 115, a masked multi-headed self-attention 130, a first add 135, a second layer norm 140, a pointwise feedforward network 145, and a second add 150. Depending on the implementation, the functions of the add and norm layers may be combined and represented as an add & norm layer, and the detailed configuration may be changed in that some layers may be omitted, added, or rearranged. For example, depending on the implementation, dropout layers (not shown) for preventing over-fitting may be added to the necessary positions.

In FIG. 1, the input sequence Input Xᵢₙᵢₜ may be a sequence of input tokens, and the input transducer 105 may generate an input token ID sequence by representing each token included in the input sequence as a token ID and may perform a token embedding that transduces the token ID into an embedded vector corresponding to the token ID and a positional embedding that represents the position of each token in the input sequence. Therefore, the input sequence Input Xᵢₙᵢₜ is transduced into an embedded vector sequence through this process, and the embedded vector sequence is input to the first encoder/decoder block 110 in the form of a matrix Input X.

Inside each encoder/decoder block 110, 155, or 160, a self-attention operation is performed through a masked multi-headed self-attention 130 layer, and a process of transducing the input is performed through a pointwise feed-forward network. In this process, first layer norm 115 and second layer norm 140 layers may be appropriately placed and perform normalization on an output of a previous layer, and the first add 135 and second add 150 layers may be appropriately placed and adopted for a residual connection.

An output generated by a final encoder/decoder block 160, which has passed through the stacked encoder/decoder blocks 110, 155, and 160 (the number of stacked layers, n, is appropriately determined depending on the model), is transduced into a logit through an operation with a transposed matrix of a matrix used for embedding performed by the input transducer 105 in the transposed embedding layer 165, and then probability calculation is performed in the softmax layer 170 layer to obtain a probability vector 175 for a token, thereby obtaining an output token (in the case of inference) or a loss (in the case of training).

In general, in natural language processing technology, a large corpus including tens of gigabytes and hundreds of millions of tokens is used for learning, and the set of all tokens obtained by tokenizing all sentences and documents in the corpus and removing duplicates is called a vocabulary. In the large language model (LLM) such as the transformer model, a dictionary of the encoder/decoder is constructed, and is referenced in the token embedding process performed by the input transducer 105 and the logit generation process performed by the transposed embedding 165 layer.

In the case of a transformer neural network model trained based on a specific corpus, when an unknown token that is not defined in the vocabulary of the encoder/decoder is input, it may cause an error in operation or negatively affect the quality or representational power of the context vector by affecting other tokens during the attention operation, thereby becoming a cause of erroneous response generation such as hallucination.

In such a conventional neural network model, it was difficult to increase the embedding dimension to enhance the representational power for inputs after training has started, and in order to normally process the unknown token, it was necessary to rebuild the dictionary including the unknown token, re-define the input tokens, and perform training from the beginning again.

In addition, a method has not yet been presented to integrate neural networks trained individually, such as a neural network trained using a Korean-based corpus and a neural network trained using an English-based corpus, to succeed the existing training while operating without errors.

### DISCLOSURE

### Technical Problem

The present disclosure presents a method for integrating a trained transformer model into another neural network and operating same without errors, thereby inheriting and extending the training already performed, without the need to retrain the transformer model from the beginning for processing unknown tokens, and enabling harmonious operation with another neural network.

In addition, the present disclosure is intended to prevent an error from occurring in operation even when a transformer model receives an input including an unknown token that is not trained, and to prevent the unknown token from affecting other tokens during an attention operation process, thereby negatively affecting the quality or representational power of a context vector.

In addition, the present disclosure provides a system structure and a training method for integrating and operating individual trained neural network systems and allowing a neural network system that is most suitable for processing the input content to contribute more to the result generation, thereby minimizing unintended erroneous response generation for inputs that have not been learned.

The technical problems addressed by the present disclosure are not limited to the above technical problems and other technical issues not specified will be readily understood by those skilled in the art from the content of the present disclosure.

### Technical Solution

A first aspect of the present disclosure proposes a method performed by a computing device for processing, through a trained neural network including n (n is an integer of 1 or greater) stacked encoder or decoder blocks, an unknown token which is not trained by the neural network, the method including inputting an input sequence including the unknown token at an i-th token position and performing a self-attention operation, wherein the performing of the self-attention operation may include generating a query matrix, a key matrix, and a value matrix, generating a query-key matrix, based on the query matrix and the key matrix, and for the query-key matrix, replacing one or more matrix elements corresponding to the i-th token position with a predetermined value.

Here, the replacing of the matrix elements with a predetermined value may include replacing one or more matrix elements of a column or row corresponding to the i-th token position in the query-key matrix with the predetermined value.

Here, the inputting of the input sequence may include representing the unknown token as a predetermined special token ID, performing embedding with an embedded vector corresponding to the special token ID, and storing position i of the unknown token.

In addition, the replacing of the matrix elements with a predetermined value may include replacing the matrix elements with a negative value which makes a result value obtained by applying a softmax function negligible.

In addition, the replacing of the matrix elements with a predetermined value may be performed by using the stored position i of the unknown token.

In addition, at least one of the n stacked encoder or decoder blocks (n is an integer of 1 or greater) may perform initialization for each output sequence by replacing an output vector corresponding to position i of the unknown token with an embedded vector of a predetermined special token.

A second aspect of the present disclosure proposes a method performed by a computing device for integrating a trained first neural network including n stacked encoder or decoder blocks (n is an integer of 1 or greater) into another neural network so as to inherit and extend the training, the method including inputting a first input sequence generated by a first input transducer and a second input sequence generated by a second input transducer to the first neural network and a second neural network, at the i-th token position, respectively, based on an input sequence including an unknown token that the first neural network has not learned, deriving a first output sequence by the first neural network, based on the first input sequence and deriving a second output sequence by the second neural network, based on the second input sequence, generating a third input sequence for a third neural network, by a first layer, based on the first output sequence and the second output sequence, and inputting the third input sequence to the third neural network, and performing back propagation training on at least the second neural network and the third neural network, based on the output sequence generated by the third neural network.

Here, the generating of the third input sequence may include replacing an output vector corresponding to the i-th token position in the first output sequence with an output vector corresponding to the i-th token position in the second output sequence.

In addition, the replaced first output sequence and the second output sequence may have an embedding dimension of 1d, and the generating of the third input sequence may further include concatenating and linearly transducing the replaced first output sequence and the second output sequence to have an embedding dimension of 1d.

In addition, the back propagation training may target a token or a token ID indicated by an index obtained by adding 1 to the index (a value indicating the position or order of each token in the input sequence) of a token or a token ID in the input sequence.

In addition, the back propagation training may include performing back propagation training on the second neural network, the third neural network, the second input transducer, and the first layer, based on the output sequence generated by the third neural network.

In addition, the first neural network may perform a self-attention operation, and the self-attention operation may include generating a query matrix, a key matrix, and a value matrix, generating a query-key matrix, based on the query matrix and the key matrix, and for the query-key matrix, replacing one or more matrix elements corresponding to the i-th token position with a predetermined value.

In addition, the replacing of the matrix elements with a predetermined value may include replacing one or more matrix elements of a column or row corresponding to the i-th token position in the query-key matrix with the predetermined value.

In addition, the first input transducer may represent the unknown token as a predetermined special token ID, perform embedding with an embedded vector corresponding to the special token ID, and store position i of the unknown token.

In addition, the replacing of the matrix elements with a predetermined value may include replacing the matrix elements with a negative value which makes a result value obtained by applying a softmax function negligible.

In addition, the replacing of the matrix elements with a predetermined value may include using position i of the unknown token stored in the first input transducer.

In addition, at least one of the n stacked encoder or decoder blocks (n is an integer or 1 or greater) of the first neural network may perform initialization for each output sequence by replacing an output vector corresponding to position i of the unknown token with an embedded vector of a predetermined special.

A third aspect of the present disclosure provides an apparatus including a processor and a memory, wherein the memory may include instructions configured to, when executed by the processor, cause the apparatus to perform a specific operation for processing an unknown token, which is not trained by a neural network, through the trained neural network including n stacked encoder or decoder blocks (n is an integer of 1 or greater). The specific operation may include inputting an input sequence including the unknown token at an i-th token position and performing a self-attention operation, wherein the performing of the self-attention operation may include generating a query matrix, a key matrix, and a value matrix, generating a query-key matrix, based on the query matrix and the key matrix, and for the query-key matrix, replacing one or more matrix elements corresponding to the i-th token position with a predetermined value.

A fourth aspect of the present disclosure proposes an apparatus including a processor and a memory, the memory including instructions configured to implement, when executed by the processor, a specific operation for integrating a first trained neural network including n stacked encoder or decoder blocks into another neural network to inherit and extend the training, wherein the specific operation may include inputting a first input sequence generated by a first input transducer and a second input sequence generated by a second input transducer to a first neural network and a second neural network, at the i-th token position, respectively, based on an input sequence including an unknown token that the first neural network has not learned, deriving a first output sequence by the first neural network, based on the first input sequence and deriving a second output sequence by the second neural network, based on the second input sequence, generating a third input sequence for a third neural network, by a first layer, based on the first output sequence and the second output sequence, and inputting the third input sequence to the third neural network, and performing back propagation training on at least the second neural network and the third neural network, based on the output sequence generated by the third neural network.

A fifth aspect of the present disclosure provides a computer-readable non-transitory storage medium, which stores instructions configured to, when executed by a processor, cause an apparatus including the processor to perform a specific operation for processing an unknown token, which is not trained by a neural network, through the trained neural network including n stacked encoder or decoder blocks (n is an integer of 1 or greater). The specific operation may include inputting an input sequence including the unknown token at an i-th token position and performing a self-attention operation, wherein the performing of the self-attention operation may include generating a query matrix, a key matrix, and a value matrix, generating a query-key matrix, based on the query matrix and the key matrix, and for the query-key matrix, replacing one or more matrix elements corresponding to the i-th token position with a predetermined value.

A sixth aspect of the present disclosure proposes a computer-readable non-transitory storage medium, which stores instructions configured to, when executed by a processor, cause an apparatus including the processor to perform a specific operation for processing an unknown token, which is not trained by a neural network, through the trained neural network including n stacked encoder or decoder blocks (n is an integer of 1 or greater). The specific operation may include inputting a first input sequence generated by a first input transducer and a second input sequence generated by a second input transducer to a first neural network and a second neural network, at the i-th token position, respectively, based on an input sequence including an unknown token that the first neural network has not learned, deriving a first output sequence by the first neural network, based on the first input sequence and deriving a second output sequence by the second neural network, based on the second input sequence, generating a third input sequence for a third neural network, by a first layer, based on the first output sequence and the second output sequence, and inputting the third input sequence to the third neural network, and performing back propagation training on at least the second neural network and the third neural network, based on the output sequence generated by the third neural network.

### Advantageous Effects

According to the present disclosure, a trained transformer model can be integrated into another neural network and operated without errors, and the learning that has already been achieved can be inherited and extended without re-training the transformer model from the beginning for processing untrained unknown tokens, so that harmonious operation with the other neural network is possible.

In addition, according to the present disclosure, errors can be prevented from occurring in operation even when a transformer model receives an input including an unknown token that is not trained, and the unknown token may be prevented from affecting other tokens during an attention operation process, thereby negatively affecting the quality or representational power of a context vector.

In addition, according to the present disclosure, it is possible to achieve a system structure and a training method which may integrate and operate individual trained neural network systems and allow a neural network system that is most suitable for processing input content to contribute more to result generation, thereby minimizing unintended erroneous response generation for inputs that have not been learned.

The effects achievable by the present disclosure are not limited to the above effects and other effects not specified will be readily understood by those skilled in the art from the content of the present disclosure.

### DESCRIPTION OF DRAWINGS

The accompanying drawings are incorporated into the detailed description and constitute a part thereof to aid in the understanding of the present disclosure, and illustrate embodiments and technical features of the present disclosure in conjunction with the detailed description.

FIG. 1 is a schematic diagram illustrating a configuration and operation of a transformer neural network model in the conventional art.

FIG. 2 is a schematic diagram illustrating a configuration of an input transducer according to an embodiment of the present disclosure.

FIG. 3 is a flowchart illustrating a process of an input transducer according to an embodiment of the present disclosure.

FIG. 4 is a schematic diagram illustrating a configuration of a masked multi-head self-attention layer according to an embodiment of the disclosure.

FIG. 5 is a flowchart illustrating a process of a masked multi-head self-attention layer according to an embodiment of the disclosure.

FIG. 6 is a flowchart illustrating a process of an encoder/decoder block according to an embodiment of the disclosure.

FIGS. 7A and 7B are diagrams illustrating subsequent token masking and unknown token masking processing according to an embodiment of the present disclosure.

FIG. 8 is a diagram illustrating a configuration for integrating a trained transformer into another neural network according to an embodiment of the present disclosure.

FIG. 9 is a diagram illustrating a process for integrating a trained transformer into another neural network according to an embodiment of the present disclosure.

FIG. 10 illustrates an apparatus capable of performing a proposed method of the present disclosure.

### MODE FOR INVENTION

Since the present disclosure may be modified into various forms and may have various embodiments, the present disclosure will be described in detail based on specific embodiments with reference to the attached drawings.

Embodiments below are provided to help a comprehensive understanding of methods, apparatuses, systems, and/or storage media described in the present specification. However, this is merely an example, and the scope of the present disclosure is not limited thereto.

In describing embodiments of the present disclosure, if it is determined that a detailed description of the known technology related to the present disclosure may unnecessarily obscure the subject matter of the present disclosure, the detailed description will be omitted. The terms which will be described below are terms defined in consideration of the functions in the disclosure, and may be different according to users, intentions of the users, or customs. Therefore, the definitions of the terms should be made based on the contents throughout the specification. The terms used in the detailed description are only for the purpose of describing the embodiments of the present disclosure, and should not be construed as limiting the present disclosure. Unless explicitly stated otherwise, a singular form of an expression includes the meaning of a plural form. In this description, expressions such as “comprising” or “including” are intended to indicate certain features, numbers, steps, operations, elements, parts or combinations thereof, and one or more than those described and it should not be construed to exclude the existence or possibility of any other characteristic, number, step, operation, element, or part or combination thereof.

In addition, terms such as “first” and “second” may be used to describe various components, but the components are not limited by the terms, and the terms are used only for the purpose of distinguishing one component from another.

### Unknown Token Replacement

If a token (unknown token) not included in training data of a pre-trained encoder/decoder is input, the encoder/decoder causes problems. The types of problems may include, for example, the case in which when an unknown token not defined in the vocabulary of the encoder/decoder is input, an error may be caused during the operation or during an attention operation, the unknown token (or a vector corresponding thereto) may affect another token (a vector corresponding thereto), which may negatively affect the quality or representational power of a context vector, resulting in incorrect response generation such as hallucination.

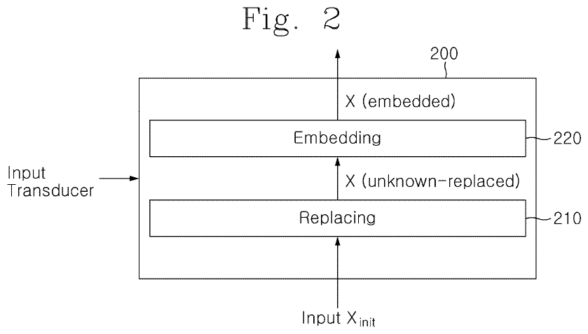

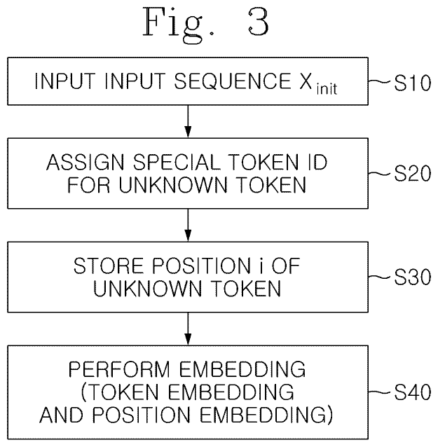

FIG. 2 is an example of a configuration of an improved input transducer 200 for solving the aforementioned problem, and FIG. 3 is a flowchart illustrating a process of the improved input transducer 200 according to an embodiment of the present disclosure. In FIG. 2, the input sequence Input Xᵢₙᵢₜ may be a sequence of input tokens (S10) and the illustrated improved input transducer 200 represents each token included in the input sequence as a token ID to generate an input token ID sequence, and in this case, a replacing 210 module assigns an ID of a special token defined in advance to the unknown token if the input sequence Input Xᵢₙᵢₜ includes an unknown token that is not in the vocabulary of the encoder/decoder (S20). Each token is usually assigned a unique integer ID value, which is referred to as a token ID, and a separate integer that is not assigned to any token is used as the ID value of a special token. In addition, the input transducer 200 separately stores a position of the unknown token (e.g., an i-th token position) on the input sequence (S30) and transmits the position for an unknown token masking process described below.

An embedding module 220 may perform a token embedding to transduce each token ID into a corresponding embedded vector (S40), and in this case, the special token ID may be transduced into a corresponding embedded vector of the special token. In addition, the embedding module 220 performs a positional embedding for representing the position of each token in the input sequence, as in the conventional art (S40). The input sequence Xᵢₙᵢₜ is transduced into an embedded vector sequence through the aforementioned process, and the embedded vector sequence is input to a first encoder/decoder block as an input X(embedded) in the form of a matrix.

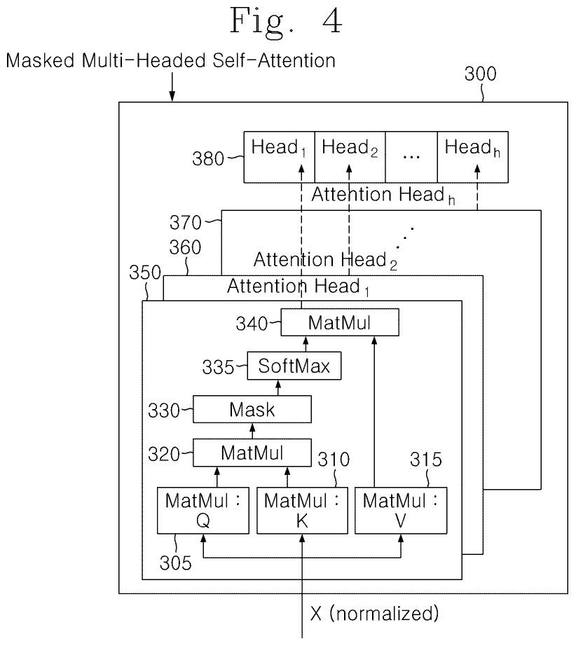

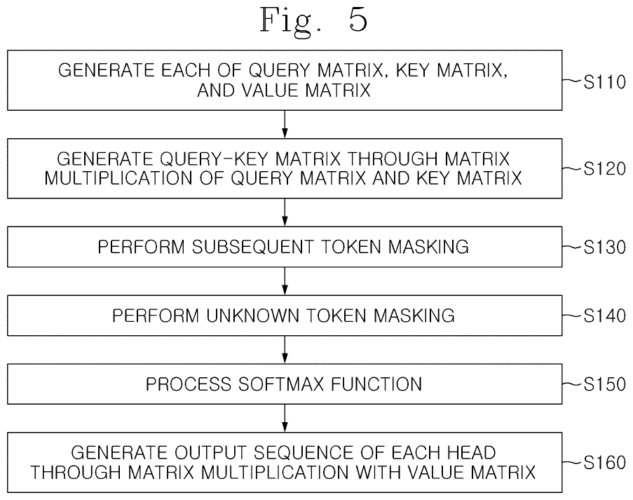

FIG. 4 is a schematic diagram illustrating a configuration of a masked multi-head self-attention 300 layer according to an embodiment of the disclosure, and FIG. 5 is a flowchart illustrating a process of a masked multi-head self-attention 300 layer according to an embodiment of the disclosure.

The improved masked multi-headed self-attention 300 layer of the embodiment performs the self-attention operation, as in the conventional art, and may include h attention heads 350, 360, and 370 that operate in parallel. Each attention head 350, 360, and 370 may obtain a query matrix Q, a key matrix K, and a value matrix V, based on an input matrix X(normalized), which is obtained by performing, if necessary, a normalization process or the like on the input matrix X(embedded) transmitted from the input transducer 200, and then generates a query matrix, a key matrix, and a value matrix for processing within each respective attention head 350, 360, or 370 by performing matrix multiplication operations with weight matrices WQ, WK, and Wv through individual matrix multiplication processes 305, 310, and 315 (S110).

Each attention head 350, 360, and 370 performs a matrix multiplication process 320 on the obtained query matrix and key matrix to generate a query-key matrix (S120) and then performs a subsequent token masking (masking for followings) process 325 (S130).

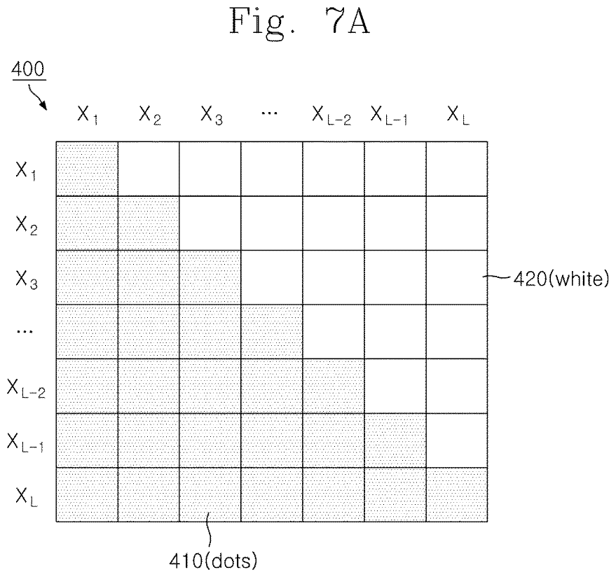

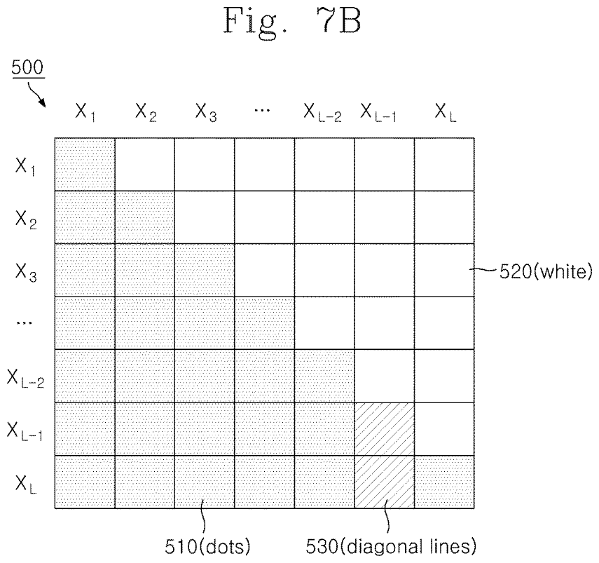

FIG. 7A is a diagram illustrating a subsequent token masking (masking for followings) 325 process. Here, FIG. 7A illustrates a case where the input sequence includes L tokens (X₁, X₂, X₃, . . . , X_{L-2}, X_{L-1}, X_{L}). In general, the subsequent token masking (masking for followings) 325 process is intended to prevent embedded vectors of tokens that appear after an i-th token from affecting the self-attention value for an embedded vector of the i-th token when obtaining the self-attention value for the embedded vector of the i-th token, in order to maintain causality, and since it is a known technology, a detailed description thereof will be omitted. In FIG. 7A, matrix elements subjected to the subsequent token masking process correspond to an area 420 indicated white at the upper right. For subsequent token masking, values of the matrix elements in the area 420 indicated in white at the upper right are replaced with −∞ (i.e., a relatively very large negative value, and since it is impossible to actually process an infinite value on a computer, a relatively large negative value that makes a result value obtained by applying the softmax function negligible).

In an embodiment of the present disclosure, an unknown token masking (masking for unknowns) 330 process may be performed in addition to the subsequent token masking process 325 process described above. FIG. 7B is a diagram illustrating an unknown token masking (masking for unknowns) 330 process according to an embodiment of the disclosure. The unknown token masking 330 process of the embodiment masks a matrix element value corresponding to the position of the unknown token in the column components of the query-key matrix, using the position information (e.g., i) of the unknown token transmitted from the input transducer 200 described above.

An area 530 indicated by diagonal lines in FIG. 7B is an example to which unknown token masking is applied, and this example shows a case where X_{L-1} is an unknown token in the input sequence including L tokens (X₁, X₂, X₃, . . . , X_{L-2}, X_{L-1}, X_{L}). Here, as shown in the drawing, the values of the elements shown as diagonal lines in FIG. 7B corresponding to the position of the unknown token X_{L-1} among the column components of the query-key matrix may be replaced with −∞ (i.e., a relatively very large negative value, and since it is impossible to actually process an infinite value on a computer, a relatively large negative value that makes a result value obtained by applying the softmax function negligible) (i.e., masked to be the same as the values of area 420 in FIG. 7A or area 520 in FIG. 7B) so that other tokens (or vectors corresponding thereto) are not affected in the subsequent processing. The area 520 indicated in white in FIG. 7B represents existing subsequent token-masked matrix elements, as in the case of FIG. 7A.

Depending on implementations, each token of the input sequence may be represented as a row vector instead of a column vector. In this case, the query-key matrix in FIG. 7B has a structure in which the rows and columns are exchanged, and the unknown token masking process 330 of this embodiment masks a matrix element value corresponding to the position of the unknown token in the row components of the query-key matrix, using the position information (e.g., i) of the unknown token transmitted from the input transducer 200 described above. In addition, the existing subsequent token masking (masking for followings) 325 process is also applied differently to the changed rows and columns.

Thereafter, the respective attention heads 350, 360, and 370 of the embodiment perform an existing SoftMax 335 process on the masked query-key matrix (S150), and then perform a matrix multiplication operation 340 on the output and the value matrix to generate an output sequence for each attention head (S160).

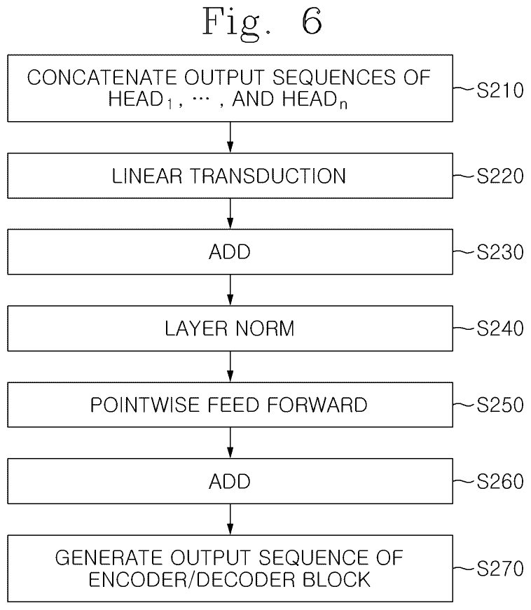

FIG. 6 is a flowchart illustrating a process of an encoder/decoder block (now shown) according to an embodiment of the disclosure. In the masked multi-headed self-attention 300 layer of the embodiment shown in FIG. 4, each of the h attention heads 350, 360, and 370 generates its own output through a similar process, and h outputs Head₁, Head₂, . . . , and Headₕ are concatenated through a concatenation 380 process (S210), and then a final output of the masked multi-headed self-attention 300 layer is obtained through a linear transduction (S220).

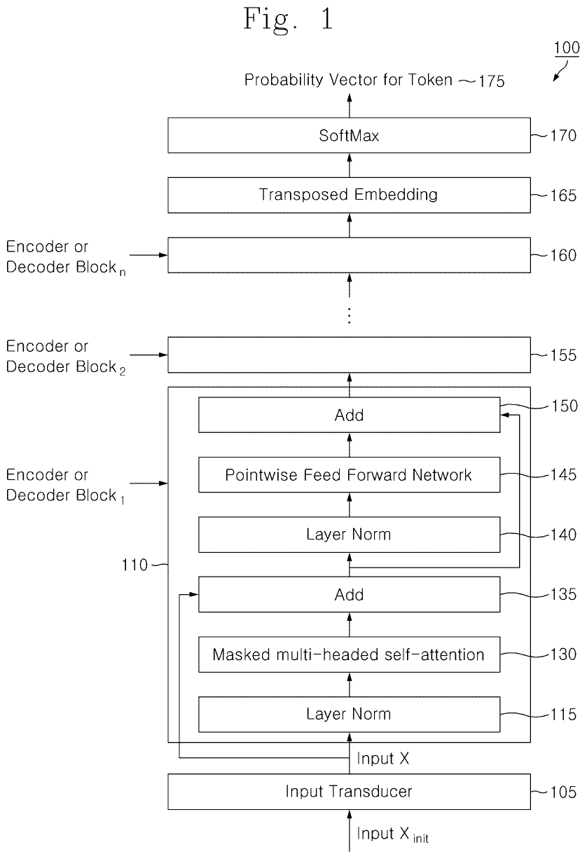

Thereafter, an output of the decoder/encoder block is obtained S270 through known layers such as a first Add S230, a second layer norm S240, a pointwise feed forward network S250, and a second Add S260 (see FIG. 1), and may be transmitted to another stacked (the number of stacks n is appropriately determined according to a model) encoder/decoder block.

Processing for Case where Unknown Token is Located at First Position of Input Sequence

Meanwhile, as shown in FIG. 7B, when applying the unknown token masking, for example, if the unknown token exists in a first token position of the input sequence, the problem related to the softmax function process of the subsequent softmax layer 335 may occur due to the unknown token masking S330. When X₁ located at the first position of the input sequence is an unknown token, the matrix elements of a first column, which correspond to the unknown token X₁, among the column components of the query-key matrix are replaced with −∞ (i.e., a relatively very large negative value, and since it is impossible to actually process an infinite value on a computer, a relatively large negative value that makes a result value obtained by applying the softmax function negligible).

However, the softmax function applied to the softmax function processing process is generally expressed as follows.

$${softmax}_{1} ( x ) = \frac{{e}^{{x}_{j}}}{{\sum }_{j = 1}^{a} {e}^{{x}_{j}}} where x ∈ {R}^{n}$$

The above equation represents the value of the i-th output element when there are a total of n output elements, and the values of the elements of the output of the softmax function are real numbers between 0 and 1, and the sum of all elements is 1, so the values may be interpreted as the probability for each input element. The softmax function is widely used in neural networks, such as a transformer, by utilizing these properties.

However, in the case where the unknown token exists in the first token position in the input sequence, all the matrix elements of the first column of the query-key matrix corresponding to the position are filled with the value −∞, and as a result, when the subsequent token masking is considered together, all elements of the first row of the query-key matrix are filled with the value −∞, so that the softmax function loses its original meaning of representing the probability of each input element, and accordingly, an error may occur in the subsequent processing. Furthermore, even if both the first and second tokens are unknown tokens, the same problem may occur in the rows corresponding to the tokens X₁ and X₂.

To solve this problem, and to apply unknown token masking (masking for unknown) without affecting the performance of the trained transformer, a vector corresponding to the position of the unknown token in the output sequence obtained as the output of the encoder/decoder block may be replaced (initialized) with an embedded vector for the special token used by the initial input transducer 200. The initialization process may be performed for the outputs of all encoder/decoder blocks of each layer in the case of stacked encoder/decoder blocks.

According to this initialization, a context vector for the position corresponding to the unknown token, which is output from a final encoder/decoder block, is the same as the embedded vector for the unknown token generated by the initial input transducer. According to the present embodiment, the context vector corresponding to already learned tokens, other than the unknown token, output from the final encoder/decoder block is a vector in which the influence of the unknown token is excluded, and the influences of the other tokens are reflected. Therefore, when fine-tuning an already trained neural network model, after obtaining the final context vector for each token vector of the input token sequence using the unknown token processing technique of the embodiment, the existing pre-trained neural network may be utilized as it is by substituting only a vector of the unknown token with another desired vector. In addition, according to the embodiments described above, even when an unknown token is input, it is possible to operate the trained transformer error-free without increasing the embedding dimension.

Integrating Trained Transformer into Another Neural Network

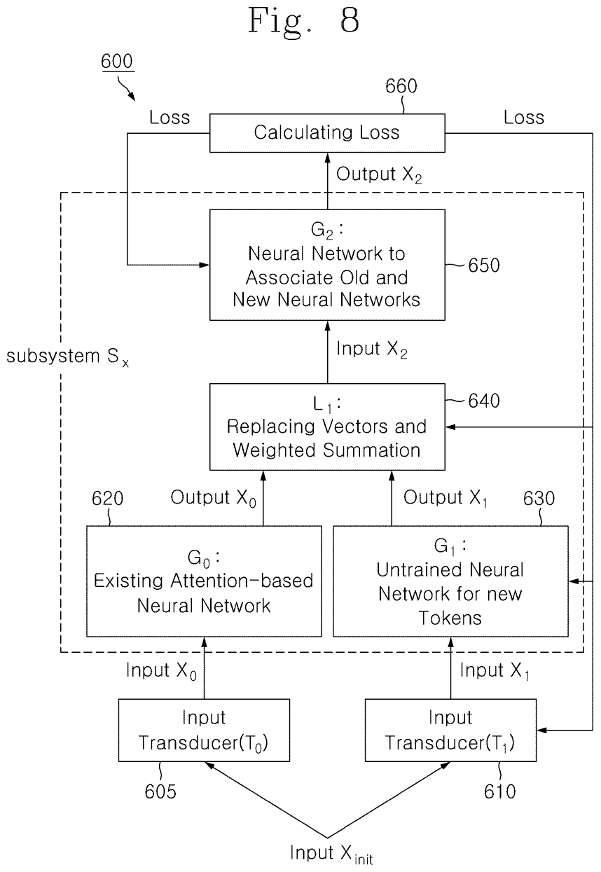

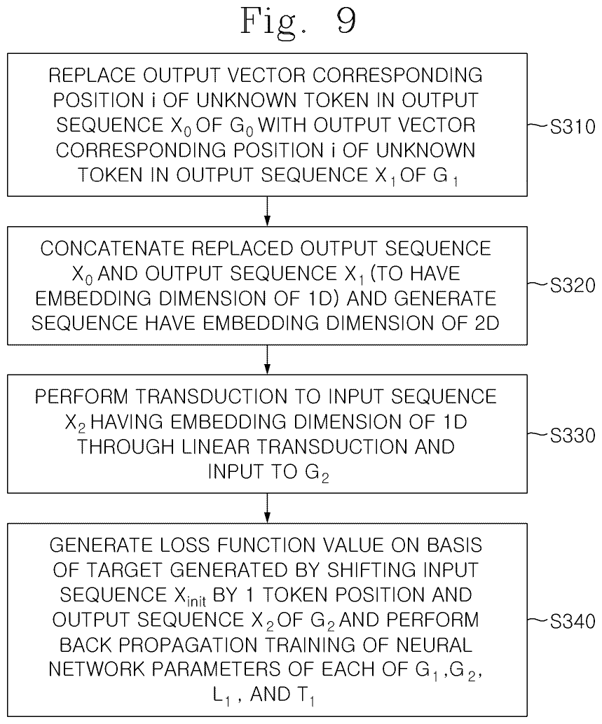

FIG. 8 is a diagram illustrating a configuration for integrating a trained transformer 620 into another neural network 650 according to an embodiment of the present disclosure. FIG. 9 is a diagram illustrating a process for integrating a trained transformer 620 into another neural network 650 according to an embodiment.

In FIG. 8, G₀ 620 represents a trained neural network, and G₁ 630 represents a separate neural network added for learning of unknown tokens, which are not used in training of G₀ 620 (i.e., not included in the vocabulary of G₀), that is, unknown tokens from the perspective of G₀ 620, and additional training data including the unknown tokens. In addition, G₂ 650 represents a separate neural network for the integration and cumulative learning of G₀ 620 and G₁ 630. G₀ 620 is preferably a transformer neural network model having a typical stacked encoder/decoder block as described above in relation to the unknown token replacement technique, but G₁ 630 and G₂ 650 may be any neural network that generates an output sequence from an input sequence, and there is no particular limitation on the type thereof. This configuration of the embodiment is intended to implement cumulative learning, which inherits the learning content of the existing G₀ 620 and allows subsequent additional learning to be more advanced based on the existing learning. To this end, the unknown token masking technique may be applied, which allows the trained neural network described above to operate without error even when an unknown token is input.

### First Input Transducer and Second Input Transducer

As shown in FIG. 8, input transducers T₀ 605 and T₁ 606 are provided for G₀ 620 and G₁ 630, respectively. Here, the input transducers T₀ 605 and T₁ 606 receive the input sequence (Input Xᵢₙᵢₜ) together and generate output matrices Output X₀ and Output X₁ for inputting to G₀ 620 and G₁ 630, respectively. The input sequence Xᵢₙᵢₜ may be a sequence of input tokens. Here, T₀ 605 has a configuration basically identical to that of the input transducer described above with reference to FIGS. 2 and 3, and G₀ 620 has a configuration basically identical to that of the stacked encoder/decoder block described above with reference to FIGS. 4, 5, and 6.

T₀ 605 and T₁ 610 each have a neural network for embedding. The training for each of the neural network parameter of T₀ 605 and G₀ 610 that have already been trained may not be performed, and neural network parameters of T₁ 610 may be initialized with the values of the neural network parameters of T₀ 605 before the training is performed, thereby enabling more efficient training.

T₀ 605 assigns a special token ID to the unknown token according to the unknown token replacement process described above if the input sequence for additional training (Input Xᵢₙᵢₜ) includes an unknown token that was not used when training G₀ 620 (i.e., not in the dictionary of G₀), and converts IDs into an embedded vector corresponding to each of the special token ID and other token IDs to generate an input sequence Input X₀ in the form of a matrix. T₁ 610 builds a vocabulary thereof based on additional training materials (corpus, documents, etc.) and transduces tokens included in the input sequence Input Xᵢₙᵢₜ for additional training into embedded vectors corresponding to respective token IDs, thereby generating an input sequence Input X₁ in the form of a matrix. T₀ 605 and T₁ 610 may perform embedding with embedded vectors of the same size in the embedding dimension of 1d. As described above, the parameters of the embedding matrix of T₀ 605, which have already been trained, do not change during the additional learning process.

### Structure of First Neural Network and Second Neural Network

In the case of G₀ 620, the existing stacked encoder/decoder block structure of the trained transformer is mostly used as it is and integrated into other neural networks 630 and 650, and the neural network parameter values are also applied as inherited. That is, the neural network parameters of G₀ 620 are not retrained in the additional training process. However, as described above with reference to FIGS. 4, 5, and 7b, the unknown token masking 330 process for processing the case of unknown token input is added to the masked multi-headed self-attention 300 layer in the encoder/decoder blocks of G₀ 620, and a process (not shown) for initializing the final output of each encoder/decoder block is added.

Furthermore, as shown in FIG. 8, Output X₀, which is the output of the final encoder/decoder block of G₀ 620, may be merged with Output X₁, which is the output of G₁ 630, in the L₁ 640 layer after being normalized once more, if necessary.

Meanwhile, G₁ 630 may be constructed based on additional training data, have a vocabulary that includes new tokens that G₀ 620 has not learned, and may be formed in any structure, such as a stacked encoder/decoder. Output X₁, which is the output of G₁ 630, may have the same sequence length as Output X₀, which is the output of G₀ 620, and Output X₁ is also normalized once more and then merged with Output X₀, which is the output of G₀ 620, in the L₁ 640 layer.

### Generation of Inputs for Third Neural Network (Replacing Vectors and Weighted Summation)

The L₁ 640 layer may perform a vector replacement process for replacing vectors corresponding to unknown tokens (i.e., unknown tokens that G₀ has not learned) among the output vectors included in Output X₀, which is the output of G₀ 620, with vectors located in positions corresponding to the unknown tokens in the input sequence Input Xᵢₙᵢₜ among the vectors included in Output X₁, which is the output of G₁ 630 (S310).

In some embodiments, L₁ 640 may further perform a weighted summation process. For example, when the vectors included in the result of applying the vector replacement process described above to Output X₀, which is the output of G₀ 620, and the vectors included in Output X₁, the output of G₁, have a 1d-dimensional embedding, the vectors included in the result of applying the vector replacement process to Output X₀ and the vectors included in Output X₁ corresponding thereto are respectively concatenated in the embedding dimension direction to generate vectors having a 2d-dimensional embedding (S320), and then the vectors are linearly transduced back into a 1d-dimensional vector by multiplying the 2d×1d weight matrix to be used as the input of G₂ 650. If necessary, layer normalization may further be performed on the 1d-dimensional vector obtained as described above. Through this process, the 1d-dimensional input sequence Input X₂ obtained is input to G₂ (S330). In the additional training process, each component of the above-described 2D×1D weight matrix is trained to reduce the loss. Through this process, the output Output X₀ of G₀ 620 and the output Output X₁ of G₁ 630 may be integrated into a single matrix having the same size as Input X₀ and Input X₁ through the L₁ 640 layer before being input to G₂ 650.

### Output Generation of Third Neural Network

G₂ 650 may be a general stacked encoder/decoder model or another neural network model. G₂ 650 may obtain the final output, Output X₂, by processing the input sequence Input X₂ through, for example, stacked encoder/decoder blocks as shown in FIG. 1, transducing the result into corresponding logits in a transposed embedding layer through an operation with a transposed matrix of the embedding matrix used during embedding, and performing a known process such as calculating probabilities in a softmax layer. In this case, the transposed embedding layer for the final output generation of G₂ 650 may use a transposed matrix of the embedding matrix used by the input transducer T₁ 610 of G₁ 610 for embedding.

### Transmission of Loss and Back Propagation Learning

The output X₂, which is the final output of G₂ 650, is compared with the target to calculate a loss, and the neural network parameters such as G₁ 630, G₂ 650, L₁ 640, and T₁ 610 are learned through back propagation (S340). For example, as in the learning process of a general transformer, a sequence in which the tokens (or token IDs) of the input sequence Xᵢₙᵢₜ are shifted to the left by one token position may be used as a target. As a result, the index of each token (or token ID) is reduced by 1 compared to before the shift. Here, the index refers to a value indicating the position or order of each token ID in the input sequence (e.g., if the input sequence includes 4 tokens, the index=1, . . . , 4). However, for efficient use of the memory, it is also possible to use a token (or token ID) indicated by an index obtained by adding 1 (i.e., +1) to the index of a specific token (or token ID) in the input sequence Input Xᵢₙᵢₜ as the target, without performing operations such as shifting, so that the input sequence Input Xᵢₙᵢₜ already stored in the memory is used as the target as it is. For example, for the token ID X₁ that appears first (i.e., index=1) in the input sequence Input Xᵢₙᵢₜ, the target becomes the token ID X₂ that appears second (i.e., index=1+1=2) in the input sequence Input Xᵢₙᵢₜ.

The sequence obtained from the final output, Output X₂, of G₂ 650 is compared with the target and used to calculate the loss value. The calculated loss value is transmitted to G₂ 650, G₁ 630, L₁ 640, and T₁ 610, and then back propagation training is performed (S340).

Through the above-described embodiments, it was confirmed that the vocabulary of the trained G₀ 620 may be substantially expanded, and that inheritance of concepts already trained by G₀ 620, acquisition of concepts learned from newly learned data, and harmony with existing concepts may all be achieved. Therefore, according to the embodiments, it is possible to integrate the already trained transformer into another neural network to achieve inheritance, expansion, and harmonization of existing training. In addition, it is particularly noteworthy that it was confirmed that learning is performed without causing over-fitting even when the amount of newly learned data is small compared to the model size. In this embodiment of the present disclosure, systems trained with Korean corpora and systems trained with English corpora, which have been trained separately, may be integrated and operated, and a system most suitable for processing the input content, among the systems, may play a greater role in generating the results, thereby minimizing the generation of unintended incorrect responses (i.e., hallucinations) to inputs for which training has not been performed.

Apparatus to which Proposed Method of Present Disclosure is Applicable

FIS. 10 illustrates an apparatus 120 capable of performing a proposed method of the present disclosure.

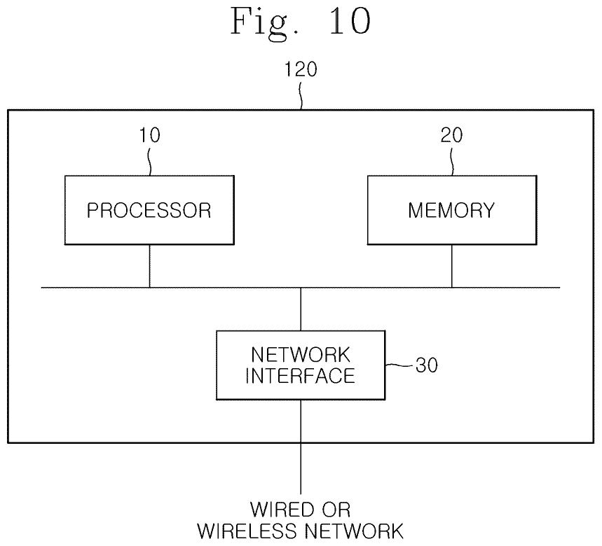

Referring to FIG. 10, the apparatus 120 may be configured to implement a process for processing an unknown token that is not trained by a neural network through the proposed method of the present disclosure and the trained neural network according to the method, or a process for inheriting and expanding the learning by integrating the learned first neural network into another neural network. For example, the apparatus 120 may be a computing device, a server device, a terminal device, a network device, or the like for performing the process of the disclosure.

For example, the apparatus 120 to which the proposed method of the present disclosure may include a network device, such as a repeater, a hub, a bridge, a switch, a router, and a gateway, a computer apparatus, such as a desktop computer and a workstation, a mobile terminal, such as a smartphone, a portable device, such as a laptop computer, a home appliance, such as a digital TV, a transportation mean, such as a vehicle, and the like. For another example, the apparatus 120 to which the present disclosure may be applied may be included as a portion of an application specific integrated circuit (ASIC) realized in a system-on-chip (SoC) form.

The memory 20 may be operatively connected to the processor 10, store programs and/or instructions for processing and controlling of the processor 10, and store data and information used in the present disclosure, control information required for data and information processing according to the present disclosure, temporary data generated during an information processing process, and the like. The memory 20 may be realized as a storage apparatus, such as a read only memory (ROM), a random-access memory (RAM), an erasable programmable read only memory (EPROM), an electrically erasable programmable read-only memory (EEPROM), a flash memory, a static RAM (SRAM), a hard disk drive (HDD), and a solid state drive (SSD).

The processor 10 may be operatively connected to the memory 20 and the network interface 30 and controls an operation of each module in the apparatus 120. Specifically, the processor 120 may perform various control functions for performing the proposed method of the present disclosure. The processor 120 may be referred to as a controller, a microcontroller, a microprocessor, a microcomputer, and the like. The proposed method of the present disclosure may be realized by hardware, firmware, software, or a combination thereof. In case that the present disclosure is realized using hardware, an application specific integrated circuit (ASIC) or a digital signal processor (DSP), a digital signal processing device (DSPD), a programmable logic device (PLD), a field programmable gate array (FPGA), and the like, which are configured to perform the present disclosure, may be included in the processor 10. In case that the proposed method of the present disclosure is realized using firmware or software, the firmware or the software may include instructions related to a module, procedure, or function configured to perform functions or operations required for realizing the proposed method of the disclosure, and the instructions may be stored in the memory 20 or in a computer-readable storage medium (not shown) separately from the memory 20 and configured to, when executed by the processor 10, cause the apparatus 120 to realize the proposed method of the present disclosure.

Furthermore, the apparatus 120 may include a network interface device 30. The network interface device 30 may be operatively connected to the processor 10, and the processor 10 may control the network interface device 30 to transmit or receive a wireless/wired signal carrying information and/or data, a signal, a message, and the like through a wireless/wired network. The network interface device 30 supports various communication standards, such as IEEE 802 series, 3GPP LTE(-A), 3GPP 5G, and the like, and may transmit and/or receive a control information and/or data signal in accordance with such communication standards. The network interface device 30 may be realized outside the apparatus 120, if necessary.

The embodiments described above are combinations of the components and features of the present disclosure in a predetermined manner. Each component or feature should be considered as optional unless explicitly stated otherwise. Each component or feature may be implemented without being combined with another component or feature. In addition, it is also possible to configure an embodiment of the present disclosure by combining some components and/or features. The order of the operations described in the embodiments of the present disclosure may be changed. Some components or features of any embodiment may be included in another embodiment, or may be replaced with corresponding components or features of another embodiment. It is obvious that claims not having an explicit citation relationship in the claims may be combined to configure an embodiment or may be included as a new claim by amendment after the filing.

### INDUSTRIAL APPLICABILITY

The present disclosure may be applied to various apparatuses such as a computing device, a server device, a terminal device, and a network device for performing learning and inference of an attention-based neural network.

1. A method performed by a computing device for processing, through a trained neural network comprising n (n is an integer of 1 or greater) stacked encoder or decoder blocks, an unknown token which is not trained by the neural network, the method comprising:
inputting an input sequence comprising the unknown token at an i-th token position; and
performing a self-attention operation,
wherein the performing of the self-attention operation comprises:
generating a query matrix, a key matrix, and a value matrix;
generating a query-key matrix, based on the query matrix and the key matrix; and
for the query-key matrix, replacing one or more matrix elements corresponding to the i-th token position with a predetermined value.

2. The method of claim 1, wherein the replacing of the matrix elements with a predetermined value comprises, for the query-key matrix, replacing one or more matrix elements of a column or row corresponding to the i-th token position with a predetermined value.

3. The method of claim 1, wherein the inputting of the input sequence comprises representing the unknown token as a predetermined special token ID, performing embedding with an embedded vector corresponding to the special token ID, and storing position i of the unknown token.

4. The method of claim 1, wherein the replacing of the matrix elements with a predetermined value comprises replacing the matrix elements with a negative value which makes a result value obtained by applying a softmax function negligible.

5. The method of claim 3, wherein the replacing of the matrix elements with a predetermined value uses stored position i of the unknown token.

6. The method of claim 1, wherein at least one of the n (n is an integer of 1 or greater) stacked encoder or decoder blocks performs initialization for each output sequence by replacing an output vector corresponding to position i of the unknown token with an embedded vector of a predetermined special token.

7. A method performed by a computing device for integrating a trained first neural network comprising n (n is an integer of 1 or greater) stacked encoder or decoder blocks into another neural network to inherit and extend the training, the method comprising:
based on an input sequence comprising, at an i-th token position, an unknown token which is not trained by the first neural network, inputting a first input sequence generated by a first input transducer and a second input sequence generated by a second input transducer to the first neural network and a second neural network, respectively;
deriving a first output sequence by the first neural network, based on the first input sequence, and deriving a second output sequence by the second neural network, based on the second input sequence;
generating, by a first layer, a third input sequence for a third neural network, based on the first output sequence and the second output sequence, and inputting the third input sequence to the third neural network; and
performing back propagation training on at least the second neural network and the third neural network, based on an output sequence generated by the third neural network.

8. The method of claim 7, wherein the generating of the third input sequence comprises replacing an output vector corresponding to the i-th token position in the first output sequence with an output vector corresponding to the i-th token position in the second output sequence.

9. The method of claim 8, wherein the replaced first output sequence and the second output sequence have an embedding dimension of 1d, and
wherein the generating of the third input sequence comprises performing concatenation and linear transformation of the replaced first output sequence and the second output sequence to have an embedding dimension of 1d.

10. The method of claim 7, wherein the back propagation training targets a token or a token ID indicated by an index obtained by adding 1 to an index of a token or a token ID in the input sequences.

11. The method of claim 7, wherein the performing of the back propagation training comprises performing back propagation training on the second neural network, the third neural network, the second input transducer, and the first layer, based on an output sequence generated by the third neural network.

12. The method of claim 7, wherein the first neural network performs a self-attention operation, and
wherein the self-attention operation comprises:
generating a query matrix, a key matrix, and a value matrix;
generating a query-key matrix, based on the query matrix and the key matrix; and
for the query-key matrix, replacing one or more matrix elements corresponding to the i-th token position with a predetermined value.

13. The method of claim 12, wherein the replacing of the matrix elements with a predetermined value comprises, for the query-key matrix, replacing one or more matrix elements of a column or row corresponding to the i-th token position with a predetermined value.

14. The method of claim 12, wherein the first input transducer represents the unknown token as a predetermined special token ID, performs embedding with an embedded vector corresponding to the special token ID, and stores position i of the unknown token.

15. The method of claim 12, wherein the replacing of the matrix elements with a predetermined value comprises replacing the matrix elements with a negative value which makes a result value obtained by applying a softmax function negligible.

16. The method of claim 14, wherein the replacing of the matrix elements with a predetermined value comprises using position i of the unknown token stored in the first input transducer.

17. The method of claim 7, wherein at least one of the n (n is an integer of 1 or greater) stacked encoder or decoder blocks of the first neural network performs initialization for each output sequence by replacing an output vector corresponding to position i of the unknown token with an embedded vector of a predetermined special token.

18. (canceled)

19. (canceled)

20. A computer-readable non-transitory storage medium storing instructions configured to, when executed by a processor, cause an apparatus comprising the processor to perform a specific operation for processing, through a trained neural network comprising n (n is an integer of 1 or greater) stacked encoder or decoder blocks, an unknown token which is not trained by the neural network,
wherein the specific operation comprises:
inputting an input sequence comprising the unknown token at an i-th token position; and
performing a self-attention operation, and
wherein the performing of the self-attention operation comprises:
generating a query matrix, a key matrix, and a value matrix;
generating a query-key matrix, based on the query matrix and the key matrix; and
for the query-key matrix, replacing one or more matrix elements corresponding to the i-th token position with a predetermined value.

21. A computer-readable non-transitory storage medium storing instructions configured to, when executed by a processor, cause an apparatus comprising the processor to perform a specific operation for processing, through a trained neural network comprising n (n is an integer of 1 or greater) stacked encoder or decoder blocks, an unknown token which is not trained by the neural network,
wherein the specific operation comprises:
based on an input sequence comprising, at an i-th token position, an unknown token which is not trained by a first neural network, inputting a first input sequence generated by a first input transducer and a second input sequence generated by a second input transducer to the first neural network and a second neural network, respectively;
deriving a first output sequence by the first neural network, based on the first input sequence, and deriving a second output sequence by the second neural network, based on the second input sequence;
generating, by a first layer, a third input sequence for a third neural network, based on the first output sequence and the second output sequence, and inputting the third input sequence to the third neural network; and
performing back propagation training on at least the second neural network and the third neural network, based on an output sequence generated by the third neural network.
